(19) United States
(12) Patent Application Publication
(10) Pub. No.: US 2026/0274430 A1
(43) Pub. Date: Sep. 17, 2026

(54) Low Drag Heat Exchanger

(71) Applicant: Textron Aviation Inc., Wichita, KS (US)

(72) Inventors: Robert Glynn Wiegers, Wichita, KS (US); Gonzalo Eduardo Mendoza, Wichita, KS (US); Steven Michael Klausmeyer, Wichita, KS (US)

(21) Appl. No.: 19/078,793

(22) Filed: Mar. 13, 2025

(51) Int. Cl. B64D 33/10; B64C 21/08; F28D 21/00

(52) U.S. Cl. CPC B64D 33/10; B64C 21/08; F28D 2021/0021

(57) ABSTRACT

A low drag heat exchanger for an aircraft includes an intake which allows airflow to pass against a heat exchanger disposed within an aircraft wing. After flowing past the heat exchanger, airflow may be released out of the air exit and controlled with an adjustable exhaust door configured to open and close to allow or disallow airflow out of the air exit. The door may be positioned to minimize drag produced when air is released out of the air exit.

### BACKGROUND OF THE INVENTION

### 1. Field

The disclosed embodiments relate generally to the field of aircraft. More specifically, the disclosed embodiments relate to drag reduction on aircraft.

### 2. Description of the Related Art

It is known to have fuselage and wing mounted heat exchangers on aircraft. For instance, U.S. Patent No. 9,328,650 to Reynolds et al., U.S. Patent No. 10,549,863 to Iarocci et al., and U.S. Patent No. 11,034,463 to White disclose aircraft with heat exchanger systems. More specifically, aircraft with liquid cooled engines may be equipped with a fuselage mounted heat exchanger to remove heat produced from aircraft engines. For instance, a P-51 Mustang model aircraft has a fuselage mounted heat exchanger with a variable exit door for engine cooling. It is also known to have a wing mounted heat exchanger. For instance, the Messerschmitt Bf-109 has underwing-mounted heat exchangers configured to provide engine cooling.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a low drag heat exchanger for an aircraft, the heat exchanger including: an air intake opening disposed on a leading wing edge of a wing, the air intake opening being configured to receive incoming airflow; a heat exchanger disposed at least partially within the wing such that air flowing into the air intake opening passes through the heat exchanger and then out of an exhaust opening disposed on an underside of the wing; and an adjustable exhaust door configured to control airflow out of the exhaust opening, wherein opening the adjustable exhaust door allows airflow out of the exhaust opening and closing the adjustable exhaust door disallows airflow out of the exhaust opening.

In some embodiments, the techniques described herein relate to a heat exchanger including a diffuser wherein the diffuser directs airflow to the heat exchanger from the air intake opening.

In some embodiments, the techniques described herein relate to a heat exchanger wherein the air intake opening is recessed into and curved to connect to aerodynamic contours of the wing.

In some embodiments, the techniques described herein relate to a heat exchanger wherein the adjustable exhaust door includes a hinge configured to pivot the adjustable exhaust door between fully open, partially open, and closed positions for controlling airflow through the exhaust opening.

In some embodiments, the techniques described herein relate to a heat exchanger wherein the adjustable exhaust door includes louvers configured to pivot open and closed for controlling airflow through the exhaust opening.

In some embodiments, the techniques described herein relate to a heat exchanger wherein the adjustable exhaust door includes a slide plate configured to slide between open and closed positions for controlling airflow through the exhaust opening.

In some embodiments, the techniques described herein relate to a heat exchanger including a forward aerodynamic ramp and a rearward aerodynamic ramp configured to smoothly connect the adjustable exhaust door to aerodynamic contours of the wing.

In some embodiments, the techniques described herein relate to a heat exchanger wherein the adjustable exhaust door is adjusted to an open, partially open, or closed position to minimize drag when airflow is allowed out of the exhaust opening.

In some embodiments, the techniques described herein relate to a method for having a low drag heat exchanger, the method including: collecting aircraft flight information, wherein the aircraft flight information includes data corresponding to air passing into an air intake opening, being directed through a heat exchanger, and passing out of an exhaust opening, the air intake opening and the exhaust opening being configured on an aircraft frame. determining an adjustment based on the aircraft flight information, the adjustment corresponding to an adjustable exhaust door configured to allow or disallow air from passing out of the exhaust opening; and implementing the adjustment to the adjustable exhaust door.

In some embodiments, the techniques described herein relate to a method wherein the adjustment is determining an optimal adjustable exhaust door position which minimizes drag when airflow is allowed out of the exhaust opening.

In some embodiments, the techniques described herein relate to a method including determining the adjustment based on current aircraft flight conditions.

In some embodiments, the techniques described herein relate to a method including determining the adjustment based on predicted aircraft flight conditions.

In some embodiments, the techniques described herein relate to a method including disposing the air intake opening onto a leading wing edge and aerodynamically coupling the air intake opening with aerodynamic contours of the wing edge.

In some embodiments, the techniques described herein relate to a method including disposing the adjustable exhaust door on an underside of a wing and aerodynamically coupling the adjustable exhaust door with aerodynamic contours of the wing.

In some embodiments, the techniques described herein relate to a low drag heat exchanger system for an aircraft, the system including: an air intake opening configured to receive air, wherein the air intake opening is disposed on a forward facing portion of an aircraft frame; an adjustable exhaust door configured to pivot open and closed relative to an exhaust opening disposed on the aircraft frame; a heat exchanger disposed at least partially internal of the aircraft frame wherein air is directed towards the heat exchanger when air passes into the air intake opening and out of the exhaust opening; a controller including: a decision making component configured to determine an adjustment based on information collected by an aircraft information component wherein the adjustment corresponds to the adjustable exhaust door being in an open, partially open, or closed position; and a door actuation component configured to implement the adjustment to the adjustable exhaust door.

In some embodiments, the techniques described herein relate to a system wherein the decision making component determines the position of the adjustable exhaust door to minimize drag created from releasing airflow out of the exhaust opening.

In some embodiments, the techniques described herein relate to a system wherein the decision making component determines the adjustment based on at least one of an aircraft airspeed, an aircraft altitude, air ambient temperature, a coolant temperature, an air intake velocity, an air exit velocity, an air exit temperature downstream of the heat exchanger, an air static pressure, an aircraft power setting, an aircraft state of flight, and aircraft temperature limits for short or long term flight phases.

In some embodiments, the techniques described herein relate to a system including a diffuser configured to direct airflow from the air intake opening to the heat exchanger.

In some embodiments, the techniques described herein relate to a system wherein the diffuser decreases momentum of airflow from the air intake opening before airflow enters the heat exchanger.

In some embodiments, the techniques described herein relate to a system wherein the adjustable exhaust door is substantially flush with an underside of an aircraft lifting surface.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a cross-sectional diagram of a low drag heat exchanger in accordance with embodiments of the present disclosure;

FIG. 2A is a partially internal side perspective view of the low drag heat exchanger of FIG. 1 with an adjustable exhaust door closed;

FIG. 2B is a partially internal side perspective view of the low drag heat exchanger of FIG. 1 with the adjustable exhaust door of FIG. 2A fully opened;

FIG. 2C is a partially internal side perspective view of the low drag heat exchanger of FIG. 1 with the adjustable exhaust door of FIG. 2A partially opened;

FIG. 3A is a side view of the adjustable exhaust door of FIG. 2A with a hinge;

FIG. 3B is a side view of the adjustable exhaust door of FIG. 2A with a slot hinge;

FIG. 3C is a side view of a louvered adjustable exhaust door;

FIG. 3D is a side view of the adjustable exhaust door of FIG. 2A with a slide plate;

FIG. 4 is a block diagram depicting a control system for the low drag heat exchanger of FIG. 1; and

FIG. 5 is a block diagram depicting a method for the low drag heat exchanger of FIG. 1.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments disclosed herein provide a low drag heat exchanger and control system for an aircraft. Aircraft having actively cooled systems, such as engines, generators, high power electronics, or other specialized equipment, require significant heat rejection means to control the temperature of the cooling fluid. To maintain adequate system function, the cooling systems may circulate relatively warm fluid away from the engine or other systems to a heat exchanger which substantially may cool the fluid. In current systems, the heat exchangers may be placed on the aircraft airframe such that air passing by the airframe circulates through the heat exchanger and cools the fluid before circulating back to the engine or system requiring cooling. Currently, heat exchanger systems may create drag due to suboptimal disposal of the air after it has passed through the heat exchanger resulting in air flow momentum losses. Additionally, when warm air exits out from the aircraft through the exit area, the relatively slow moving air released may increase boundary layer drag along the airframe. In some current systems, the heat exchanger may increase the surface area of the airframe. Additional area or contour disruptions, especially along wing leading edges, may cause the wings to be substantially less aerodynamically efficient and may increase drag. A system is needed which reduces the drag of aircraft having heat exchanger systems.

Embodiments herein provide a system for having a low drag heat exchanger installation and control system for an aircraft. The heat exchanger system is configured substantially within an aerodynamic profile of an aircraft frame such that the aerodynamic profile and shape of the aircraft is preserved. The heat exchanger system includes an adjustable exhaust door configured to control airflow out of an air exhaust opening. In this way, the velocity and rate of airflow expelled from the exit opening may be substantially controlled and optimized to mitigate drag (e.g. increasing the momentum of the air exhaust). In some embodiments, a control system may control the exhaust door and optimally control the degree of openness of the door based upon current or predicted flight conditions.

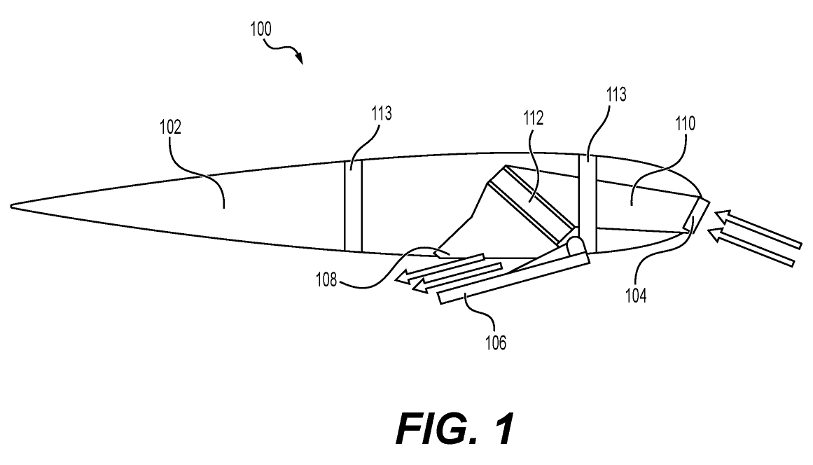

With reference to the following FIGS. 1-5, a low drag heat exchanger 100 is shown and described. FIG. 1 shows a cross-sectional diagram of an aircraft wing 102 which reveals the low drag heat exchanger 100 disposed inside of wing 102. In embodiments, the low drag heat exchanger 100 includes an air intake opening 104 and an adjustable exhaust door 106. The door 106 is configured to open and close and adjust to various degrees of openness to control airflow out of an air exhaust opening 108 disposed on an underside of wing 102. Ambient air received into the intake opening 104 travels through a diffuser 110 followed by a heat exchanger 112 disposed within the wing 102. In this way, ambient air is received into intake 104 (indicated by the arrows in FIG. 1) and heat is transferred from the heat exchanger 112 into the passing flow of air, causing the temperature of the air to substantially increase before exiting through the exhaust opening 108. In some embodiments, the low drag heat exchanger 100 shown within wing 102 may be disposed within other types of lifting surfaces or devices such as sponsons. In some embodiments, the low drag heat exchanger 100 may have ducts which pass through aircraft structure 113.

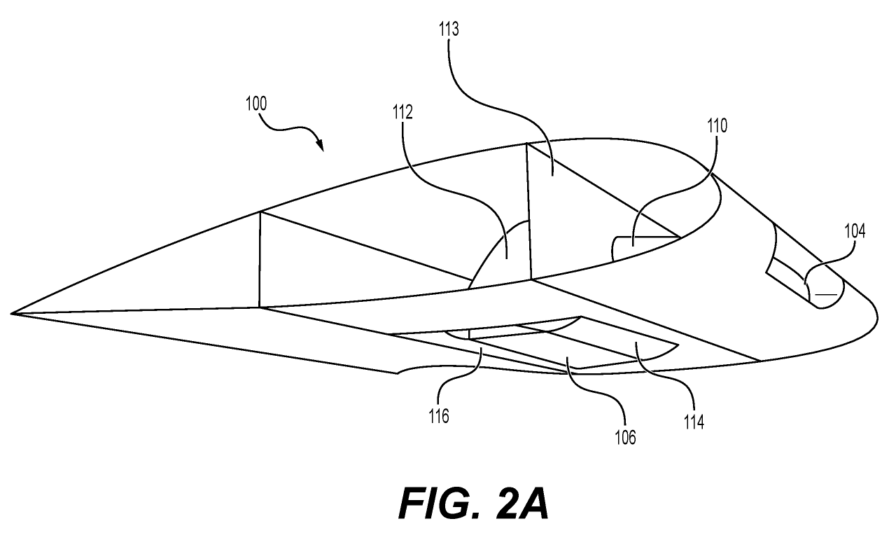

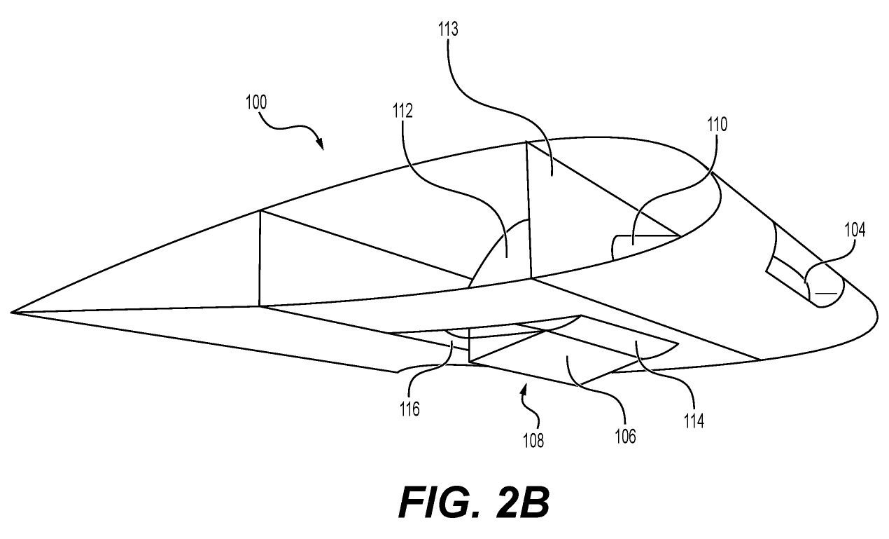

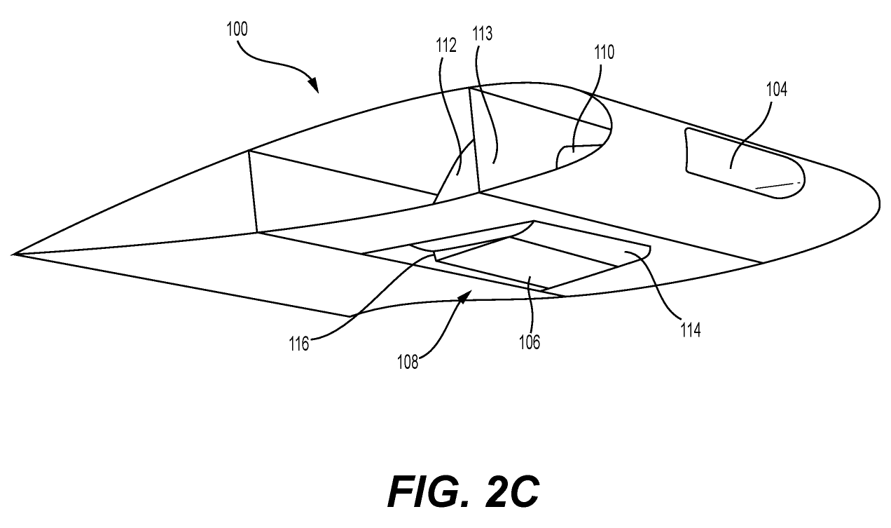

With reference to FIGS. 2A and 2B, the intake opening 104 is recessed into a leading edge of wing 102. The intake opening 104 may be placed on an aircraft frame such as a sponson or a wing and may be configured within the profile of the airfoil ahead of a forward structural spar. In embodiments, the air intake opening 104 is sized and positioned to receive airflow to satisfy cooling requirements of low speed and high power flight conditions. In embodiments, the air intake opening 104 is recessed into the leading edge of wing 102 and has walls which smoothly connect the air intake opening 104 to the aerodynamic shape of the wing’s leading edge. The air intake opening 104 is aerodynamically coupled to wing 102 thereby substantially maintaining the original aerodynamic profile of the wing 102. In some embodiments, the air intake opening 104 may be configured to be closed. It may be advantageous to close the air intake opening 104 due to flight conditions in which debris or ice may be ingested into the air intake opening 104 or in situations where cooling is not needed. When the door 106 is partially opened or fully closed, airflow into the air intake opening 104 may be reduced which may increase drag. In embodiments, the geometry, shape, and profile of the air intake opening 104 is such that drag resulting from the closure or partial closure of the door 106 is substantially reduced when the door 106 is partially open or fully closed.

In embodiments, the heat exchanger 112 is a liquid to air heat exchanger configured to receive a circulating fluid from a liquid cooled aircraft engine or other high temperature aircraft system, such as an energy converter or high power electronic device, and transfer heat from the circulating fluid to passing airflow via radiative fins/coils or other geometric configurations providing adequate surface area for the air to extract heat from the circulating fluid, as is known in the art. More specifically, fluid is circulated in thermal contact with an engine or system to prevent it from overheating. As the fluid is heated by the system being cooled, the fluid is circulated away to a heat exchanger, such as heat exchanger 112. At the heat exchanger, the fluid is circulated through coils or cavities which are in thermal contact with the airflow, which cools the fluid to a reduced temperature. Cooled fluid is then recirculated back to the engine or system and the process is repeated.

In embodiments, the heat exchanger 112 is aerodynamically coupled to and recessed within the wing 102 such that the aerodynamic contours of the wingare substantially maintained. In some embodiments, the heat exchanger 112 is recessed into a sponson of the aircraft. In embodiments, the heat exchanger 112 is positioned such that air passes into the air intake opening 104 during flight, which then passes through the diffuser 110 and directly through the heat exchanger 112. In embodiments, the diffuser 110 reduces the velocity of the air through air intake opening 104 before passing through the heat exchanger 112. The reduced velocity created by the diffuser 110 may minimize drag by reducing pressure losses through the heat exchanger 112 and may allow for maximum change of temperature change in the airflow. The circulation of air directly through the heat exchanger 112 allows for fluid within the heat exchanger 112 to be cooled before the fluid circulates back to the aircraft system. After passing through the heat exchanger 112, the air flows out of the air exhaust opening 108. When air flows out of exhaust opening 108, the airflow may be accelerated, slowed, and/or directed using the adjustable exhaust door 106.

With reference to FIGS. 2A and 2B, the adjustable exhaust door 106 may be in a fully opened or a fully closed position, and may be adjusted to various degrees of openness therebetween to control the flow rate of air released from the air exhaust opening 108. In FIG. 2A, the adjustable exhaust door 106 is in a closed position, and in FIG. 2B the adjustable exhaust door 106 is in an open position. When the door 106 is in an open position, airflow is allowed through the exhaust opening 108, and when the door 106 is closed airflow is disallowed through the exhaust opening 108. The exhaust opening 108 is disposed on the underside of wing 102 and is covered or blocked when the adjustable exhaust door 106 is in a fully closed position as shown in FIG. 2A. The exhaust door 106, when fully closed, may have a bump which protrudes slightly outwardly from the aerodynamic contour of wing 102 and into the airstream. A forward aerodynamic ramp 114 and a rearward aerodynamic ramp 116 provide a smooth transition from the underside surface of the wing 102 to the adjustable exhaust door 106. The ramps 114 and 116 allow for the wing 102 surface to smoothly transition from the wing contour to the adjustable exhaust door 106 and may substantially maintain the aerodynamic shape of the wing 102. For example, the ramp 114 provides a smooth transition to the leading edge of the exhaust door 106 and the ramp 116 provides a smooth transition to the trailing edge of the door 106 such that the profile leading up to the door 106 is substantially smooth and contoured with the wing 102 surface. In embodiments, the adjustable exhaust door 106 also includes beveled side edges which substantially match the slope of the ramps 114 and 116. In some embodiments, the ramps 114 and 116 may not be disposed on the wing 102 and instead the door 106 may be flush with the surface of the wing. This may substantially allow the door 106 to open and close as described in embodiments herein, and be substantially flush with the lofted surface of the wing 102 when closed.

In operation, when the adjustable exhaust door 106 is opened (FIG. 2B), the door 106 pivots open from its leading edge which is directly adjacent to an edge of ramp 114. When door 106 pivots open, air within the diffuser 110 exits out of the exhaust opening 108. During operation, the adjustable exhaust door 106 may be opened to a fully open position as shown in FIG. 2B, or it may be partially opened to various degrees of openness as shown in FIG. 2C. When the door 106 is opened, the angle of the door 106 directs air out of the exhaust opening 108 in a rearward direction relative to the wing 102. When the door 106 is opened to different degrees of openness, the flow rate and flow velocity of the air directed out of the exhaust opening 108 changes accordingly. For instance, if the door 106 is adjusted so that it is in a partially opened position, the velocity of the air being directed out of the exhaust opening 108 is generally greater than if the door 106 is in a fully open position as ram pressure at the inlet and lower pressure through the exhaust resist changes in mass flow rate. If the door 106 is partially closed, a reduction in mass flow will occur, but the ensuing reduction in outlet area (e.g. exhaust opening 108) would result in the flow maintaining reasonably high velocity, and hence adequate momentum, through the exhaust opening 108. At the extreme, with the door 106 fully closed, flow rate and flow velocity both naturally stop. In this configuration, the airplane engine or system would not be provided with cooling. In embodiments, adjusting the door 106 to various degrees of openness to control the velocity and mass flow of the expelled air may be used to substantially decrease drag when air is directed out of the exhaust opening 108.

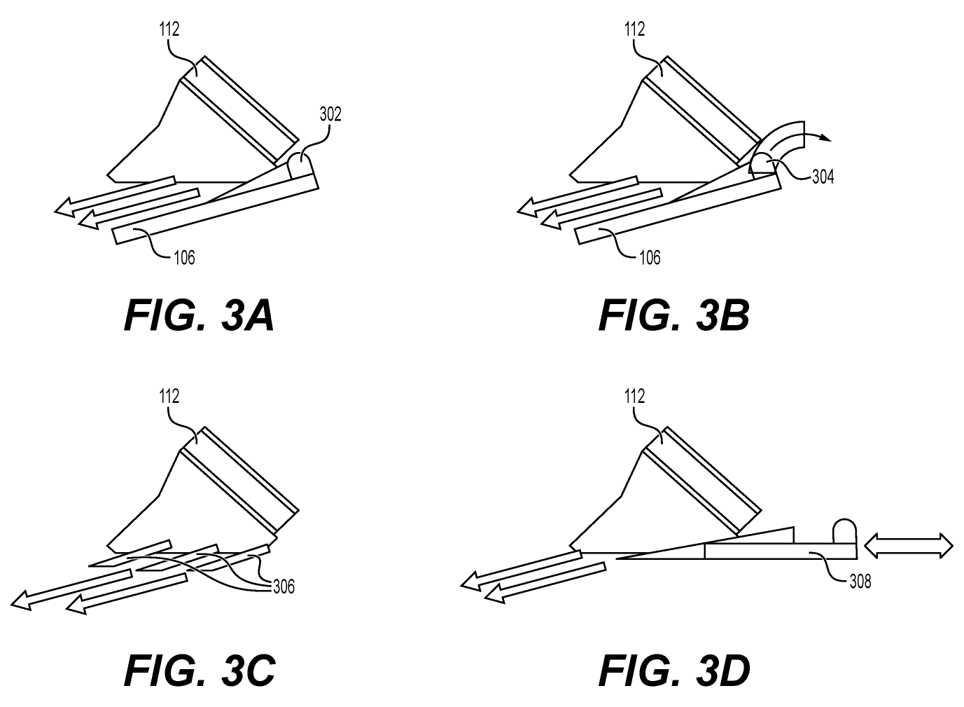

In embodiments, with reference to FIGS. 3A-3C, the adjustable exhaust door 106 may be made adjustable using a variety of different configurations. For instance, in FIG. 3A, the adjustable exhaust door 106 is configured with a hinge 302, which allows the door 106 to pivot open and closed relative to the exhaust opening 108. In FIG. 3B, the door 106 is configured with a slot hinge 304, which allows the door 106 to slide and pivot relative to the exhaust opening 108. In FIG. 3C, the exhaust opening 108 is shown with a louvered exhaust door 306. In embodiments, the louvered exhaust door 306 includes a plurality of door segments which pivot open or closed to control airflow through the exhaust opening 108. FIG. 3C shows three door segments, but one, two, or more than three door segments may be employed without departing from the scope hereof. In FIG. 3D, the door 106 is configured with a slide plate 308 which is configured to slide along straight or curved tracks to allow the door 106 to control airflow from the exhaust opening 108. In other embodiments, the door 106 may have other configurations to be made adjustable for controlling airflow out of the exhaust opening 108.

In some examples, aircraft flight information is referenced to determine an adjustment for an optimal degree of openness for the door 106. In embodiments, aircraft flight information may include aircraft airspeed, altitude, ambient air temperature, coolant temperature (e.g., the temperature of the fluid in the heat exchanger 112), air intake velocity through air intake opening 104, air exit velocity through exhaust opening 108, air exit temperature downstream of heat exchanger 112, air static pressure at the exhaust opening 108, aircraft engine or system power settings, and aircraft state of operation (e.g. climbing, cruising, descending, taxiing), and aircraft temperature limits for short or long term flight phases. In some embodiments, a control system receives aircraft flight information and provides notifications for a pilot to control the openness of the door 106, and in other embodiments, the control system is configured to control the door 106 automatically. In some implementations, predicted aircraft flight information is referenced to determine an adjustment for the door 106.

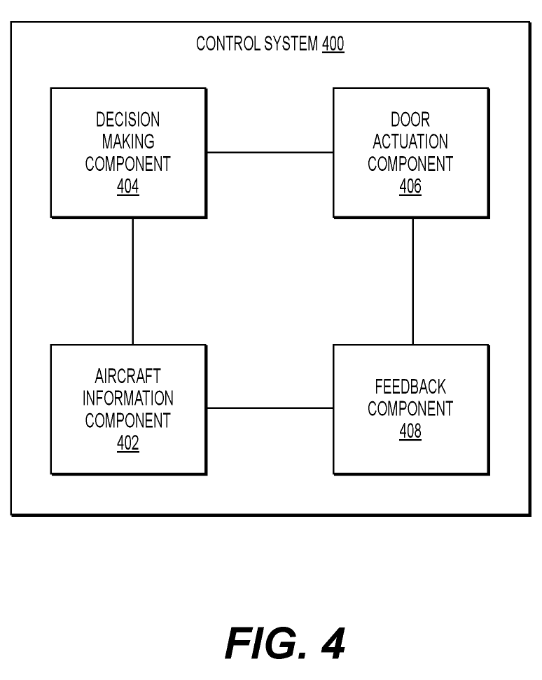

FIG. 4 shows a block diagram depicting a control system 400. The control system 400 includes an aircraft information component 402, a decision making component 404, a door actuation component 406, and a feedback component 408. In embodiments, the aircraft information component 402 collects information from various instruments and sensors configured to detect current aircraft diagnostic information associated with flight conditions as well as information corresponding to the air intake opening 104 and exhaust opening 108. In embodiments, the aircraft information component 402 may include information such as aircraft airspeed, altitude, ambient air temperature, coolant temperature (i.e. the temperature of the fluid in the heat exchanger 112), air intake velocity through air intake opening 104, air exit velocity through exhaust opening 108, aircraft engine or system power settings, and aircraft state of flight (i.e. climbing, cruising, descending), and aircraft temperature limits for short or long term flight phases. In some embodiments, the aircraft information component 402 may include predicted flight conditions. For instance, predicted flight conditions may include a rate of climb, a rate of change of atmospheric temperature, a rate of acceleration, and a rate of power application. In embodiments, a rate of climb may indicate anticipated changes in air density. As an aircraft climbs at constant airspeed, it may be necessary to provide additional cooling as the air density drops especially for turbocharged powerplants, which may maintain power at altitude despite lower air density. In embodiments, a rate of change of atmospheric temperature may be related to the aircraft rate of climb. For instance, a climb may result in reduced mass flow (less density) and a lower, higher, or unchanging temperature with altitude depending on weather patterns. Additionally, flying into an atmospheric front may result in measurable rates of change in temperature. In embodiments, a rate of acceleration may provide a predictive means for anticipating changes in available mass flow for cooling. This may allow for smooth door position changes. In embodiments, a rate of coolant or engine exhaust may substantially allow for prediction of cooling demands instead of reacting to cooling demands at an instantaneous time. In embodiments, rate of power application may indicate a need for cooling by opening of the door 106. In embodiments, a rates of change for power, altitude, airspeed, and temperature may be substantially more beneficial to control of the door 106 than responding to instantaneous conditions. Identifying rates of change for the conditions described above as well as others may allow the door 106 to be opened and closed strategically based upon predicted flight conditions which may allow for the aircraft to have greater optimization than responding to current flight conditions. The aircraft information component 402 is configured to communicate with the decision making component 404 such that the information collected by aircraft information component 402 may be communicated to the decision making component 404.

The decision making component 404 is configured to determine an adjustment for the door 106 based on the information from the aircraft information component 402. The adjustment may be a position of door 106 to minimize drag created from the air released from the exhaust opening 108. The adjustment may be an optimal position (i.e. degree of openness) of the adjustable exhaust door 106 to reduce drag based on the information collected by the aircraft information component 402. The decision making component 402 may include algorithms, reference tables, data tables, or other components configured to determine an adjustment for an optimal position for the exhaust door 106 based upon current flight conditions or predicted flight conditions. For instance, the decision making component 404 may determine an adjustment for the door 106 based on the information collected by aircraft information component 402 such as the temperature of airflow passing by the heat exchanger 112 (and the temperature of the heat exchanger coolant) as well as the temperature and velocity of the air passing into air intake opening 104 and out of exhaust opening 108. The decision making component 404 may determine an adjustment which may be an optimal degree of openness for the door 106 which minimizes the drag caused by the air being released through exhaust opening 108. For instance, it may be advantageous for drag reduction to release air from the exhaust opening 108 at a velocity equal to or faster than the velocity of the aircraft airspeed. To increase the velocity of the air being released, the decision making component 404 may determine an adjustment for having a smaller degree of openness for the door 106 (i.e. further closed than open) which will decrease the cross section area of the exhaust opening 108 and substantially increase the momentum of the released air through exhaust opening 108. In some situations, the decision making component 404 may determine it is more advantageous for the door 106 to have a greater degree of openness which allows for the door 106 to be more opened than closed and increases the cross section area of the exhaust opening 108. For instance, the door 106 may be fully closed when the fluid temperature of the heat exchanger 112 is cooler than necessary. This may occur in instances when the heat exchanger 112 is not in use, or during prolonged periods of aircraft descent when systems are using particularly low amounts of power. The door 106 may be fully open when the temperature of the circulating fluid of the heat exchanger 112 is above normal operating temperatures. This may occur when the aircraft is climbing which causes the airspeed to be substantially low while the power usage in aircraft systems is particularly high. Other instances when the door 106 may be fully open is when the aircraft is on the ground running at high power. The door 106 may be partially opened when the aircraft is in a state of cruising in order to optimize cooling and reduce drag.

The decision making component 404 may communicate with the door actuation component 406 to provide physical control of the door 106. The door actuation component 406 may include various actuation mechanisms configured to pivot/slide the door 106 open and closed. In embodiments, and described above in FIGS. 3A-3D, the door 106 may include different types of configurations and hinges allowing the door 106 to achieve varying degrees of openness relative to the exhaust opening 108. The decision making component 404 may provide commands to the door actuation component 406 corresponding to adjusting the position of door 106 to minimize the drag of the air released out of the exhaust opening 108.

The feedback component 408 may communicate with the aircraft information component 402 in real time or near real time to provide the position of the door 106 and the temperature and velocity of the air exiting out of the exhaust opening 108. In this way, the decision making component 404 may determine if the low drag heat exchanger 100 is operating correctly and may allow for the door 106 to be opened and closed based on real time or near real time flight conditions.

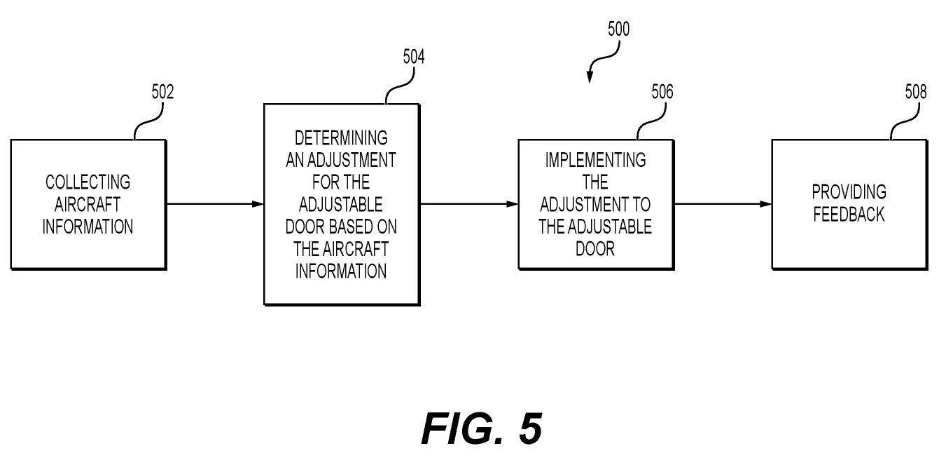

FIG. 5 shows a method 500 for controlling the release of air for a low drag heat exchanger.

A step 502 comprises collecting aircraft information. In embodiments, aircraft information may include aircraft airspeed, coolant temperature (i.e. the temperature of the fluid in the heat exchanger 112), air intake velocity through air intake opening 104, air exit velocity through exhaust opening 108, aircraft engine or system power settings, and aircraft state of flight (i.e. climbing, cruising, descending), and aircraft temperature limits for short or long term flight phases. In embodiments, sensors or instruments configured to detect real time aircraft diagnostic information may be used to collect the aircraft information. In some embodiments, predicted aircraft flight conditions may be calculated and collected as aircraft information.

A step 504 comprises determining an adjustment for an adjustable door based on the aircraft information. In embodiments, decision making component 404 may determine an adjustment for the adjustable exhaust door 106 based on the aircraft information from the aircraft information component 402. The door 106 is configured to adjust to various degrees of openness which allows or disallows airflow out of exhaust opening 108. In some instances, an adjustment may be the door 106 being partially opened or fully opened to substantially control the velocity of the airflow released from exhaust opening 108. In some embodiments, the adjustment may substantially decrease the drag produced from releasing the air out of exhaust opening 108.

A step 506 comprises implementing the adjustment to the adjustable exhaust door 106. In embodiments, the door actuation component 406 includes actuation mechanisms configured to control openness of the door 106. The decision making component 404 may communicate with the door actuation component 406 to implement the adjustment to the door 106.

A step 508 comprises providing feedback based on the adjustment to the door 106. In embodiments, sensors or other detection instruments may provide feedback which provides indication of the position of the door 106 and/or the temperature and velocity of the air exiting out of the exhaust opening 108. In this way, the decision making component 404 may determine if the low drag heat exchanger 100 is operating correctly and may adjust the door 106 according to real time or near real time conditions.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. A low drag heat exchanger for an aircraft, the heat exchanger comprising:
an air intake opening disposed on a leading wing edge of a wing, the air intake opening being configured to receive incoming airflow;
a heat exchanger disposed at least partially within the wing such that air flowing into the air intake opening passes through the heat exchanger and then out of an exhaust opening disposed on an underside of the wing; and
an adjustable exhaust door configured to control airflow out of the exhaust opening, wherein opening the adjustable exhaust door allows airflow out of the exhaust opening and closing the adjustable exhaust door disallows airflow out of the exhaust opening.

2. The heat exchanger of claim 1, comprising a diffuser wherein the diffuser directs airflow to the heat exchanger from the air intake opening.

3. The heat exchanger of claim 1, wherein the air intake opening is recessed into and curved to connect to aerodynamic contours of the wing.

4. The heat exchanger of claim 1, wherein the adjustable exhaust door comprises a hinge configured to pivot the adjustable exhaust door between fully open, partially open, and closed positions for controlling airflow through the exhaust opening.

5. The heat exchanger of claim 1, wherein the adjustable exhaust door comprises louvers configured to pivot open and closed for controlling airflow through the exhaust opening.

6. The heat exchanger of claim 1, wherein the adjustable exhaust door comprises a slide plate configured to slide between open and closed positions for controlling airflow through the exhaust opening.

7. The heat exchanger of claim 1, comprising a forward aerodynamic ramp and a rearward aerodynamic ramp configured to smoothly connect the adjustable exhaust door to aerodynamic contours of the wing.

8. The heat exchanger of claim 1, wherein the adjustable exhaust door is adjusted to an open, partially open, or closed position to minimize drag when airflow is allowed out of the exhaust opening.

9. A method for having a low drag heat exchanger, the method comprising:
collecting aircraft flight information, wherein the aircraft flight information includes data corresponding to air passing into an air intake opening, being directed through a heat exchanger, and passing out of an exhaust opening, the air intake opening and the exhaust opening being configured on an aircraft frame;
determining an adjustment based on the aircraft flight information, the adjustment corresponding to an adjustable exhaust door configured to allow or disallow air from passing out of the exhaust opening; and
implementing the adjustment to the adjustable exhaust door.

10. The method of claim 9, wherein the adjustment is determining an optimal adjustable exhaust door position which minimizes drag when airflow is allowed out of the exhaust opening.

11. The method of claim 9, comprising determining the adjustment based on current aircraft flight conditions.

12. The method of claim 9, comprising determining the adjustment based on predicted aircraft flight conditions.

13. The method of claim 9, comprising disposing the air intake opening onto a leading wing edge and aerodynamically coupling the air intake opening with aerodynamic contours of the wing edge.

14. The method of claim 9, comprising disposing the adjustable exhaust door on an underside of a wing and aerodynamically coupling the adjustable exhaust door with aerodynamic contours of the wing.

15. A low drag heat exchanger system for an aircraft, the system comprising:
an air intake opening configured to receive air, wherein the air intake opening is disposed on a forward facing portion of an aircraft frame;
an adjustable exhaust door configured to pivot open and closed relative to an exhaust opening disposed on the aircraft frame;
a heat exchanger disposed at least partially internal of the aircraft frame wherein air is directed towards the heat exchanger when air passes into the air intake opening and out of the exhaust opening;
a controller comprising:
a decision making component configured to determine an adjustment based on information collected by an aircraft information component wherein the adjustment corresponds to the adjustable exhaust door being in an open, partially open, or closed position; and
a door actuation component configured to implement the adjustment to the adjustable exhaust door.

16. The system of claim 15, wherein the decision making component determines the position of the adjustable exhaust door to minimize drag created from releasing airflow out of the exhaust opening.

17. The system of claim 15, wherein the decision making component determines the adjustment based on at least one of an aircraft airspeed, an aircraft altitude, air ambient temperature, a coolant temperature, an air intake velocity, an air exit velocity, an air temperature downstream of the heat exchanger, an air static pressure, an aircraft power setting, an aircraft state of flight, and aircraft temperature limits for short or long term flight phases.

18. The system of claim 15, comprising a diffuser configured to direct airflow from the air intake opening to the heat exchanger.

19. The system of claim 18, wherein the diffuser decreases momentum of airflow from the air intake opening before airflow enters the heat exchanger.

20. The system of claim 15, wherein the adjustable exhaust door is substantially flush with an underside of an aircraft lifting surface.
